(19) United States
(12) Patent Application Publication
(10) Pub. No.: US 2003/0079398 A1
(43) Pub. Date: May 1, 2003

(54) Insect trap

(76) Inventor: Thomas Michael Holmes, Birstwith (GB)

Correspondence Address: VENABLE, BAETJER, HOWARD AND CIVILETTI, LLP, P.O. BOX 34385, WASHINGTON, DC, 20043-9998, US

(21) Appl. No.: 10/278,995

(22) Filed: Oct. 24, 2002

(30) Foreign Application Priority Data
Oct. 25, 2001 (GB) 0125589.2

(51) Int. Cl. A01M 1/04; A01M 1/08

(52) U.S. Cl. 43/113

(57) ABSTRACT

An insect trap (10) comprises twin ultraviolet fluorescent tubes (12) with control circuitry therefor. The fluorescent tubes being behind a perforated upper portion (16) supported on brackets (18a/b). The insect trap (10) also includes a reflector (20) supported on concave brackets (22a/22b). The insect trap comprises a glue board which is secured inside the cover 16 extending the length thereof and having the same semi-circular shape as the cover (16). In this way, the surface of the glue board (24) is generally equidistant from the fluorescent tubes (12) along their length.

### FIELD OF THE INVENTION

This invention relates to an insect trap, in particular an insect trap having an insect attracting light combined with immobilisation means to trap insects attracted by the light.

### BACKGROUND OF THE INVENTION

Existing insect traps, such as those described in U.S. Pat. Nos. 5,365,690 and 5,505,017 form a flying insect trap which uses reflected and radiated light to lure insects into the trap to be immobilised on an adhesive surface within the trap. The light is reflected from an adjacent wall or ceiling surface to which the trap is attached.

Disadvantages arise with this type of device in that the adhesive surface soon becomes covered with insects that have been immobilised and is therefore no longer useful for catching further insects. This problem is exacerbated by the fact that some parts of the adhesive surface are closer to the source of light and are thereby more likely to trap insects, leading to congestion on some parts of the board. Thus the distribution of insects on the adhesive board is very uneven. Existing units have relatively large areas of waste glue board which insects will not approach, because of the larger distance from the light source.

It is an object of the present invention to address the above mentioned disadvantages.

### SUMMARY OF THE INVENTION

According to a first aspect of the present invention an insect trap comprises illumination means for attracting insects and immobilisation means for immobilising and retaining said insects, wherein a separation between the illumination means and the immobilisation means is generally constant over a majority of the lateral extent of the immobilisation means.

Preferably, the separation is generally constant over substantially all of the lateral extent or area of the immobilisation means. The separation may be in the range 2 cm to 10 cm, preferably 4 cm to 6 cm.

Preferably, a minimum distance between the illumination means and the immobilisation means is generally constant.

The insect trap thereby advantageously provides an immobilisation means in which substantially no part is more likely to receive more contacts from insects than any other part, due to the constant separation.

The illumination means is preferably a light source, preferably a fluorescent light source, more preferably an ultraviolet (UV) emitting light source. Most preferably a UV fluorescent light source.

The immobilisation means preferably comprises an adhesive covering, preferably carried on a flexible substrate. The immobilisation means may be a glue board.

The immobilisation means may be retained by a cover portion, which cover portion preferably gives a shape to which the immobilisation means conforms. The cover portion is preferably curved around the illumination means. The cover portion is preferably a half cylinder and may have a perforated surface. The cover portion may be faceted or may be a partial hexagon shape, or may form a smaller, e.g. a third, fraction of a cylinder.

The cover portion may be secured to fixings extending from a housing of the illumination means.

The insect trap may include a reflector, preferably located, in use, between the illumination means and a surface to which the insect trap is attached.

The reflector preferably extends to each of two sides of the illumination means. The reflector preferably has a concave shape. The illumination means is preferably located substantially centrally on said reflector, preferably substantially at the centre of the concave shape. The reflector preferably reflects and focuses light from the illumination means away from a surface to which, in use, the insect trap is secured.

The reflector may have a polished surface, which may be polished aluminium.

The reflector may be secured to brackets for securing the insect trap to a suitable surface. The brackets may provide the concave shape for the reflector.

A specific embodiment of the present invention will now be described, by way of example, and with reference to the accompanying drawings, in which:

### BRIEF DESCRIPTION OF THE DRAWINGS

FIG. 1 is a schematic end view of an insect trap;

FIG. 2 is a schematic side view of the insect trap;

FIG. 3 is a schematic front view of the insect trap; and

FIG. 4 is a schematic perspective view from the front and to one side of the insect trap.

### DETAILED DESCRIPTION OF THE PREFERRED EMBODIMENT

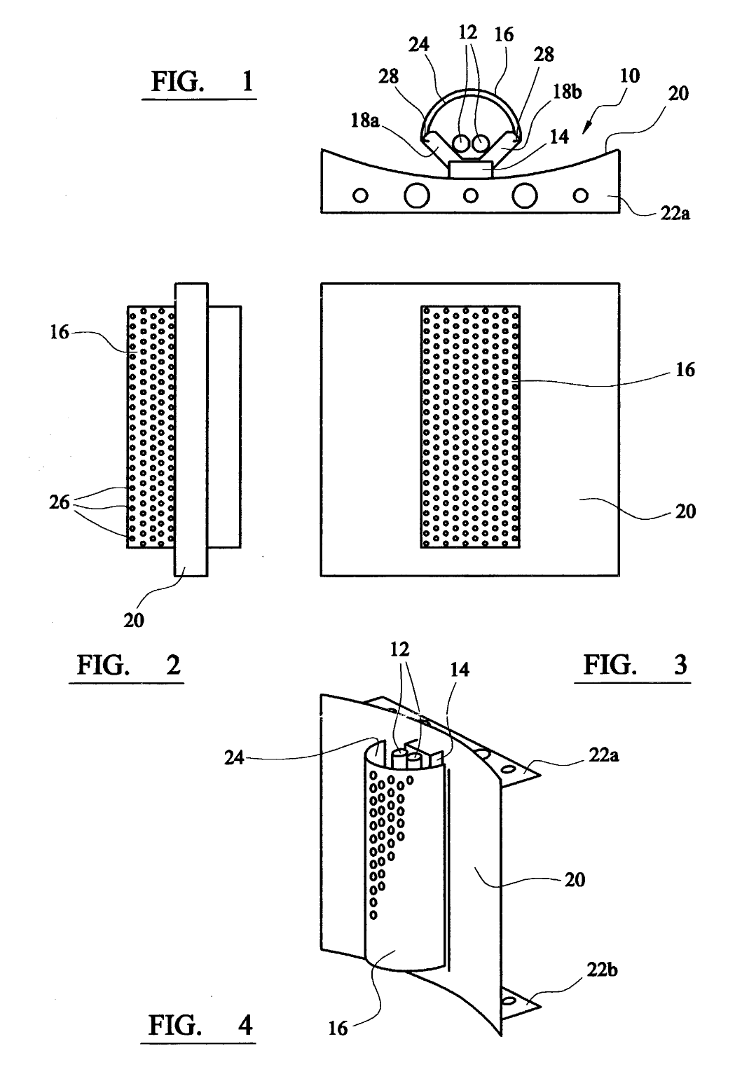

The insect trap 10 shown in FIG. 1 comprises twin ultraviolet (UV) fluorescent tubes 12 with control circuitry therefor 14, the fluorescent tubes being behind a perforated cover portion 16 supported on brackets 18a and 18b. The insect trap 10 also includes a reflector 20 supported on concave brackets 22a and 22b, which brackets can be secured to a suitable wall or other surface. The insect trap is typically powered by an electrical mains supply.

An essential part of the insect trap 10 is a glue board 24 which is secured inside the cover 16, extending the length thereof and having the same semi-circular shape as the cover 16. In this way, the surface of the glue board 24 is generally equidistant from the UV fluorescent tubes 12 along their length. The separation between glue board 24 and tubes 12 may be approximately 2 cm to 10 cm, preferably about 5 cm, being a minimum distance between the UV tubes 12 and the glue board 24.

In more detail, the glue board 24 has one surface with adhesive thereon, which may be any suitable form of adhesive for trapping and retaining insects and the like. The glue board 24 must be flexible to allow it to be flexed to the shape of the cover 16, because it is typically in sheet form when supplied. The glue board 24 is inserted into the inside of the cover 16 by bending the glue board 24 to the correct shape and sliding it in from one end.

The cover 16 has multiple perforations 26, which may allow some of the UV light from the UV fluorescent tubes 12 to pass through the cover 16 and thereby provide some attraction to insects towards the insect trap 10.

The cover 16 is secured to the brackets 18a and 18b by means of flanges 28 being received in slots in the brackets 18a/b, as shown in FIG. 1. The cover may be approximately 250 mm long. It may alternatively have a faceted shape, which could be a partial hexagon, or may have a shape less than a half cylinder, such as a third of a cylinder.

The control circuitry 14 and the UV fluorescent bulbs 12 are those typically used in insect traps 10 and are well known to the skilled worker in this field.

The brackets 18a and 18b are not continuous along the length of the insect trap 10, but simply form pairs of “legs” generally at either end of the cover 16, so that lights may pass from the UV fluorescent tubes 12 to the surface of the reflector 20.

The reflector 20 has a concave shape which serves to receive light from the UV fluorescent tubes and focus that light towards a room, to thereby provide a strongly attractive light to flying insects to lure those insects to the insect trap 10. The reflector 20 is typically made of aluminium, and has proven to be very effective when the aluminium is polished. The surprising effect of the combination of polished aluminium and the concave reflector 20 has very good properties for attracting and trapping insects. The reflector may measure approximately 300 mm by 300 mm.

An alternative surface finish for the reflector 20 is to have a painted surface with a dimpled finish, but results show that this is less good at attracting insects.

As mentioned above, the concave shape of the reflector 20 is beneficial. However, an alternative version uses a convex reflector (not shown), which may have a similar curvature to the reflector 20 shown in FIG. 1, but in reverse. This type of convex reflector may be achieved by placing a curved insert between the reflector 20 and the brackets 22a and 22b to cause the reflector 20 to form a convex curve.

The reflector 20 may be secured to the brackets 22a/22b by suitable fixing means such as screws. The brackets 22a/22b may be secured with suitable fixing means such as screws to a suitable wall or ceiling.

In use, insects are attracted to the insect trap 10 by the UV light from the UV fluorescent tubes 12. The reflector 20 has the effect of preventing most of the UV light from hitting an adjacent wall or ceiling, to thereby prevent degradation of the wall or ceiling covering, and to reflect that light outwards, in a generally focused manner. Insects are then attracted to the trap and fly towards the UV fluorescent tubes 12. Insects typically fly around the tubes directly because of heat, causing them to stray onto the glue board 24. The insects hit the glue board 24 and are retained by the adhesive on the glue board 24.

An important feature of the insect trap 10 is that all points of the glue board 24 are generally equidistant from the light source. Consequently, no part of the glue board 24 is likely to be hit by insects more frequently than any other part. Thus, parts of the glue board 24 do not become clogged with trapped insects more readily than other areas, thus leaving more usable area of the glue board 24 for a longer period of time than would be the case with a glue board only part of which is close to the light source, with remaining parts being further away. Thus, the glue board 24 in this insect trap is used more effectively and may have a longer life than glue boards in other, prior art, insect traps.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extend to any novel one, or any novel combination, of the features disclosed in this specification (including any accompanying claims, abstract and drawings), or to any novel one, or any novel combination, of the steps of any method or process so disclosed.

1. An insect trap comprises illumination means for attracting insects and immobilisation means for immobilising and retaining said insects, wherein a separation between the illumination means and the immobilisation means is generally constant over a majority of the lateral extent of the immobilisation means.

2. An insect trap as claimed in claim 1, in which the separation is generally constant over substantially all of the lateral extent or area of the immobilisation means.

3. An insect trap as claimed in claim 1, in which the separation is in the range of about 2 cm to 10 cm.

4. An insect trap as claimed in claim 1, in which a minimum distance between the illumination means and the immobilisation means is generally constant.

5. An, insect trap as claimed in claim 1, in which the immobilisation means comprises an adhesive covering carried on a flexible substrate.

6. An insect trap as claimed in claim 1, in which the immobilisation means is retained by a cover portion, which gives a shape to which the immobilisation means conforms.

7. An insect trap as claimed in claim 6, in which the cover portion is curved around the illumination means.

8. An insect trap as claimed in claim 6, in which the cover portion is a half cylinder.

9. An insect trap as claimed in claim 1, which includes a reflector located, in use, between the illumination means and a surface to which the insect trap is to be attached.

10. An insect trap as claimed in claim 9, in which the reflector reflects and focuses light from the illumination means away from a surface to which the insect trap is to be secured.

11. An insect trap comprises illumination means for attracting insects and immobilisation means for immobilising and retaining said insects, wherein a separation between the illumination means and the immobilisation means is generally constant over a majority of the lateral extent of the immobilisation means, in which the separation is generally constant and between about 2 cm and 10 cm over substantially all of the area of the immobilisation means, and in which the immobilisation means comprises an adhesive covering carried on a flexible substrate, the immobilisation means being retained by a cover portion that is curved around the illumination means.
